(19) United States
(12) Patent Application Publication
(10) Pub. No.: US 2007/0119550 A1
(43) Pub. Date: May 31, 2007

(54) Slat of a venetian blinder

(76) Inventor: Chin-Fu Chen, Taichung City (TW)

Correspondence Address: BIRCH STEWART KOLASCH & BIRCH, PO BOX 747, FALLS CHURCH, VA, 22040-0747, US

(21) Appl. No.: 11/288,296

(22) Filed: Nov. 29, 2005

(51) Int. Cl. E06B 3/12

(52) U.S. Cl. 160/236

(57) ABSTRACT

The invention discloses an improved slat of a Venetian blinder that comprises a sheet slat body, and the slat body is covered by a coat, and the coat could be made of an artificial leather having a color patter printed onto its surface and wrapped around the external periphery of the slat body by sewing, such that the Venetian blinder can change its color and pattern easily, so as to achieve the effect of changing the color pattern of the Venetian blinder.

### FIELD OF THE INVENTION

The present invention relates to an improved slat of a Venetian blinder, and more particularly to a slat of a Venetian blinder having a color pattern and such color pattern can be changed.

### BACKGROUND OF THE INVENTION

Although the general Venetian blinder made of a plastic material can have different colors produced by an integral stamping process, the change of colors and patterns is very limited. Only one color for the whole Venetian blinder or a color changing progressively from dark to light can be achieved, and the whole blinder cannot have various colors and patterns. If a window curtain is adhered with dusts, the curtain will be washed by water, but the slats of the Venetian blinders are stacked and come with certain softness, and thus it takes lots of efforts to clean the slats. Furthermore, the indoor window curtains are part of the interior decoration, and the fabric used for making the window curtains has various different beautiful color patterns to go with various different stylish decorations sewed thereon, not only providing the effect of shading sunlight, but also giving an eye-catching effect for the interior decoration. Since the Venetian blinder made of a plastic material comprises a plurality of slats and each slat is manufactured separately, therefore various different color patterns cannot be printed onto the whole slats of the blinder, and the visual effect is not as good as the window curtain made of a fabric.

The inventor of the present invention based on years of experience on the related industry to conduct extensive researches and experiments, and finally broke through the bottleneck of research and development and invented a slat of a Venetian blinder in accordance with the present invention.

### SUMMARY OF THE INVENTION

The primary objective of the present invention is to overcome the foregoing shortcomings and avoid the existing deficiencies by providing a slat of a Venetian blinder that comprises a sheet slat body, and the slat body is covered by a coat, and the coat could be made of an artificial leather, a genuine leather, or other fabrics having a color pattern printed onto its surface and wrapped around the external periphery of the slat body by sewing, such that the Venetian blinder can change its color and pattern easily to achieve the effects of providing a beautiful color pattern and changing the color pattern at a later date.

### BRIEF DESCRIPTION OF THE DRAWINGS

FIG. 1 is a perspective view of a preferred embodiment of the invention;

FIG. 2 is a cross-sectional view of a preferred embodiment of the invention; and

FIG. 3 is a perspective view of an application of the invention.

### DETAILED DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

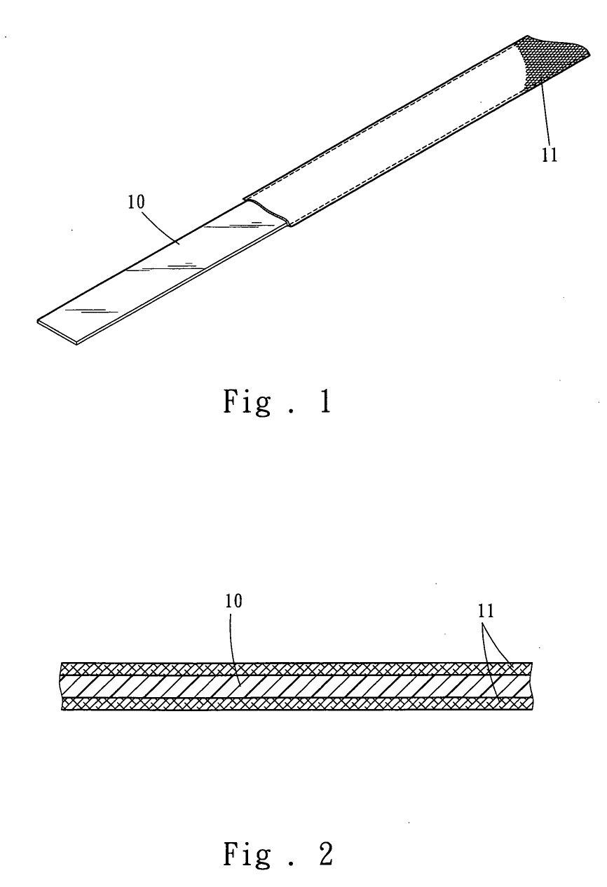

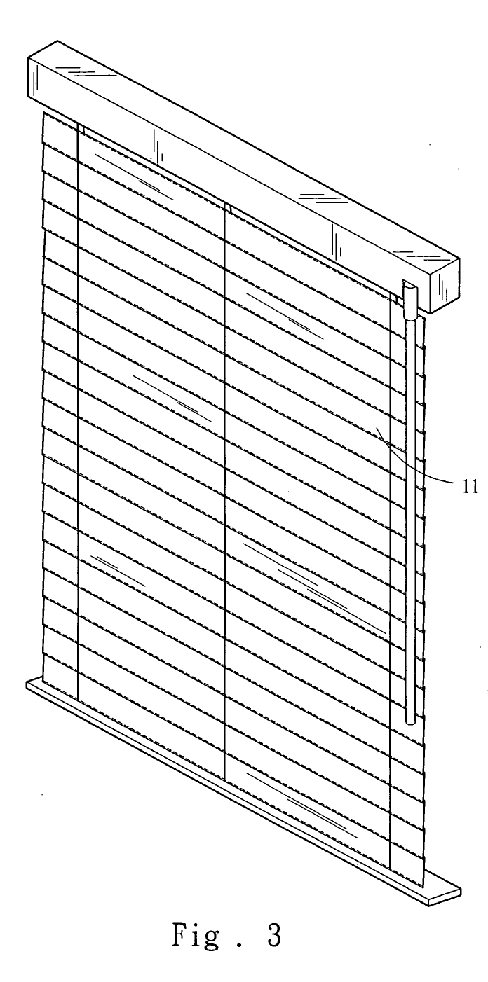

Referring to FIGS. 1 and 2, an improved slat of a Venetian blinder of the present invention comprises a rectangular sheet slat body 10, and the slat body 10 could be made of a plastic material or a wood material. A coat 11 is provided for wrapping around the periphery of the slat body 10, and the coat 11 could be made of an artificial leather, a genuine leather, or other fabrics, and the coated is attached flatly on the slat body 10 and sewed to cover the coat 11.

Referring to FIG. 3, a color pattern is printed onto the coat 11, such that the whole Venetian blinder shows a continuous stylish pattern, which can be used for shading sunlight and providing an interior decoration. After the blinder has been used for some time, the blinder can be taken down and changed to have a new coat 11 with a different color pattern printed on the surface of each slat 10, so as to save the trouble of cleaning the dusts on the Venetian blinder and changing the blinder to a new pattern anytime.

In summation of the above description, the slat body 10 of the Venetian blinder of the invention is wrapped by the coat 11, and the coat 11 is printed with various different color patterns to provide the decorative effect. Further, users can change the coat 11 anytime as needed to achieve the purpose of renewing the color pattern of the Venetian blinder. The present invention herein enhances the performance than the conventional structure and further complies with the patent application requirements and is submitted to the Patent and Trademark Office for review and granting of the commensurate patent rights.

While the invention has been described by means of specific embodiments, numerous modifications and variations could be made thereto by those skilled in the art without departing from the scope and spirit of the invention set forth in the claims.

What is claimed is:

1. An improved slat of a Venetian blinder, comprising a sheet slat body, and a coat made of a leather material and wrapped around the external periphery of said slat body, and said coat is wrapped onto said slat body by sewing.

2. The improved slat of a Venetian blinder of claim 1, wherein said slat body is made of a plastic material.

3. The improved slat of a Venetian blinder of claim 1, wherein said slat body is made of a wood material.

4. The improved slat of a Venetian blinder of claim 1, wherein said slat body is made of an artificial leather material.

5. The improved slat of a Venetian blinder of claim 1, wherein said coat is made of a genuine leather material.
